(19) United States
(12) Patent Application Publication
(10) Pub. No.: US 2004/0065067 A1
(43) Pub. Date: Apr. 8, 2004

(54) Dust-proof filter apparatus

(75) Inventors: Kuo-Wen Chen, Hsinchu (TW); Chen-Wen Yang, Hsinchu (TW)

Correspondence Address: BACON & THOMAS, PLLC, 625 SLATERS LANE, FOURTH FLOOR, ALEXANDRIA, VA, 22314

(73) Assignee: Coretronic Corporation, Hsinchu (TW)

(21) Appl. No.: 10/657,220

(22) Filed: Sep. 9, 2003

(30) Foreign Application Priority Data
Oct. 8, 2002 (TW) 091216702

(51) Int. Cl. B01D 46/00

(52) U.S. Cl. 55/493; 55/495; 55/502

(57) ABSTRACT

The present invention is to provide a dust-proof filter apparatus comprising a [symbol] -shaped pleated body which is formed by a upper base plate, at least one connection bond, and a lower base plate, at least one filter which is arranged into the body, and at least one elastic buckle assembly which consists of a clasp element and an interlocking opening. The clasp element and the interlocking opening are, respectively, located in the surface of the opening end of the body. By using the elastic buckle assembly, the filter can be fastened and loosened conveniently. In addition, the dust-proof filter apparatus can be mounted into a conditioner or cooling system to provide the fresh air.

### BACKGROUND OF THE INVENTION

1. Field of the Invention

The present invention relates to a dust-proof filter apparatus, and more particularly to an exchangeable filter for use in a dust-proof filter apparatus.

2. Description of the Related Art

A great quantity of particles will affect the efficiency of the system devices and, thus, various dust-proof apparatus for filtering particles heretofore have been designed and manufactured whether used in the air conditioner or used in the cooling system.

A conventional skill dealing with the problem is use of the filter to clean the air. The key feature is how to fix, assemble and disassemble, and clean the filter conveniently and quickly. The known art discloses a fastened filter apparatus, which is formed by the rectangular frames. Then, the filter apparatus is locked or mounted into the system. The filter couldn't exchange alone, when it was broken. It will raise the cost. A prior art exchangeable filter apparatus, as shown in FIG. 1, comprises an upper plate 1, a lower plate 2, and a filter 3. The filter 3 is arranged between the upper plate 1 and the lower base 2. The upper plate 1 and the lower plate 2 are secured with screws 4, and the filter 3 is fastened. Then, the exchangeable filter is installed into the inlet of the air conditioner or the cooling system to filter the air. When air traveling through the filter 3, particles in the air will be trapped in the filter 3 so that the filter 3 must be washed or cleaned. But the exchangeable filter apparatus has to unlock the filter 3 by screwing the screws 4 such that assembling or disassembling the exchangeable filter apparatus is inconvenient and waste time.

### SUMMARY OF THE INVENTION

An object of the invention is to provide a dust-proof filter apparatus which arranges the filter into the receiving space of the body, and is locked by the elastic buckle assembly to assembly the apparatus conveniently.

Another object of the invention is to provide a dust-proof filter apparatus, which can be mounted into a conditioner or cooling system quickly for fixing.

To achieve the above objects, the present invention provides a dust-proof filter apparatus comprising a [symbol] -shaped pleated body which is formed by a upper base plate, at least one connection bond, and a lower base plate, at least one filter which is arranged into the body, and at least one elastic buckle assembly which consists of a clasp element and an interlocking opening. The clasp element and the interlocking opening are, respectively, located in the opening end of the body. By using the elastic buckle assembly, the filter can be fastened and loosened conveniently. In addition, the dust-proof filter apparatus can be mounted into a conditioner or cooling system through a sliding way to provide the fresh air.

### BRIEF DESCRIPTION OF THE DRAWINGS

The above and other objects, advantages, and features of the present invention will be understood from the following detailed description of the invention when considered in connection with the accompanying drawings below.

FIG. 1 is an exploded view of a prior art.

FIG. 2 is a perspective view showing a dust-proof filter apparatus of the present invention.

FIG. 3 is a side view showing a dust-proof filter apparatus of the present invention.

FIG. 4 is an exploded view showing a dust-proof filter apparatus of the present invention.

FIG. 5 is a functioning view showing a dust-proof filter apparatus of the present invention.

FIG. 6 is a decomposed view showing a dust-proof filter apparatus of the present invention and a sliding way.

FIG. 7 is a combination view showing a dust-proof filter apparatus of the present invention and a sliding way.

FIG. 8 is a schematic view showing filtering dust process by a dust-proof filter apparatus of the present invention.

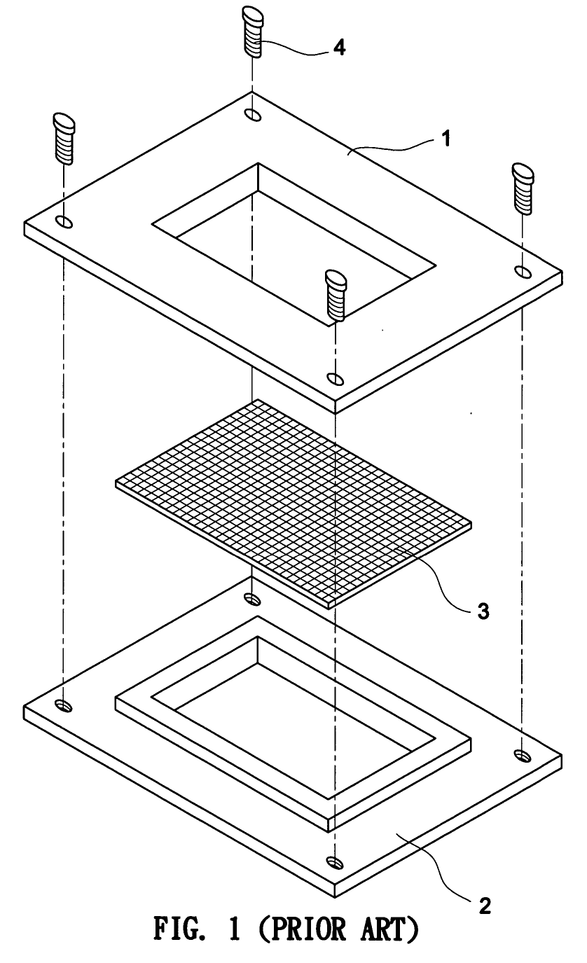

### DETAILED DESCRIPTION OF THE INVENTION

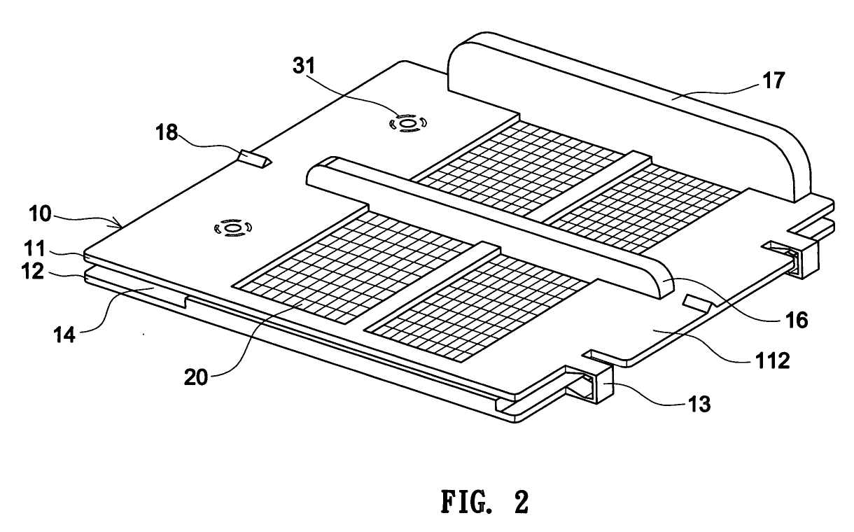

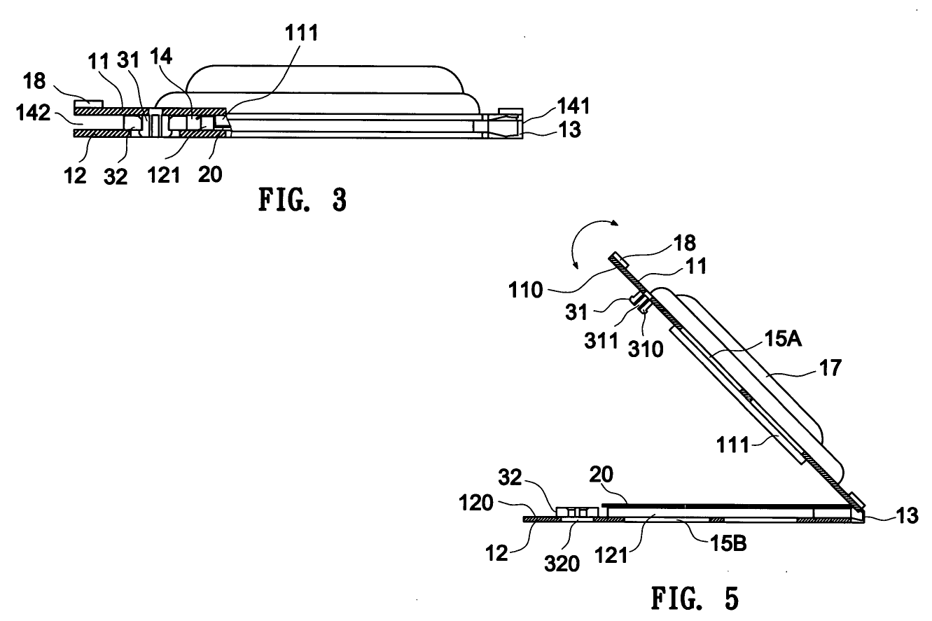

Referring to FIG. 2 and FIG. 3, a dust-proof filter apparatus of the invention comprises of a body 10, at least one filter 20, and an elastic buckle assembly, which comprises at least one clasp element 31 and at least one interlocking opening 32. The body 10 consists of a rectangular upper base plate 11, a rectangular lower base plate 12, and at least one flexible connection bond 13 to form a [symbol] -shaped pleated body 10. The upper base plate 11, the lower base plate 12 and the flexible connection bond 13 form a connection end 141, an opening end 142, and a receiving space 14 disposed in the body 10. In addition, said upper base plate 11, said lower base plate 12, and said flexible connection bond 13 can be formed in one.

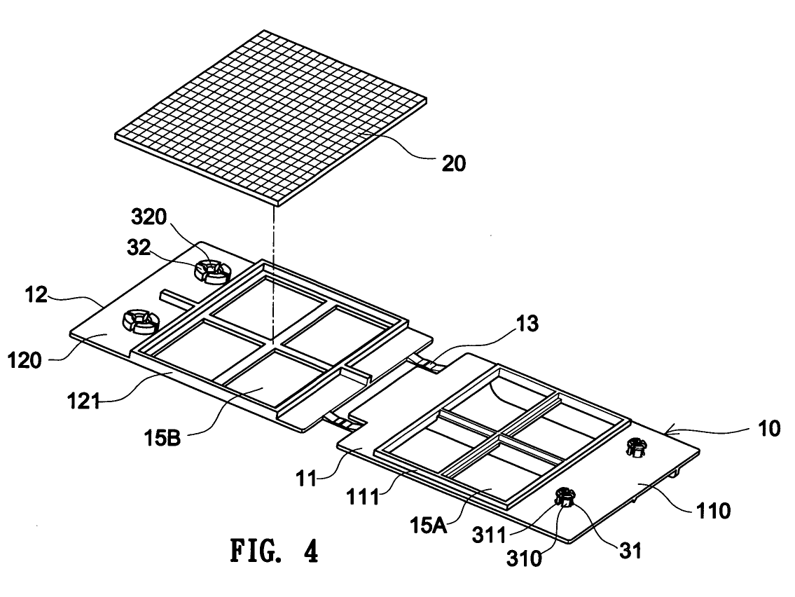

Referring to FIG. 4, the filter 20 is arranged in the receiving space 14 between the upper base plate 11 and the lower base plate 12. The upper base plate 11 and the lower base plate 12 have, respectively, at least one opening 15A and 15B corresponding to the location of the filter 20. Accordingly, with the opening 15A and 15B, air traveling through the filter 20 will have dust trapped in the filter 20 so that the circulating air will be cleaner. In this embodiment, the opening 15A and the opening 15B are, respectively, comprised of four rectangular openings. The filter 20 can be fixed by space frames between rectangular openings to prevent it from drop. At least one elastic buckle assembly consists of a clasp element 31 and an interlocking opening 32. The clasp element 31 and the interlocking opening 32 are, respectively, located in the surface of the opening end 142 of the body 10. The elastic buckle assembly could be located in the -surface of the opening end 142 opposite or adjacent to the connection end 141. In this embodiment, the elastic buckle assembly is located in the -surface of the opening end 142 opposite to the connection end 141. In addition, the clasp element 31 and the interlocking opening 32 are, respectively, located in the inside surface 110 of the upper base plate 11 and inside surface 120 of the lower base plate 12. The clasp element 31 is composed of 4 elastic pieces 310 to form a hollow cylinder. There is clearance 311 between adjacent elastic pieces 310. The elastic pieces 310 have one end fixed in the inside surface 110 of the upper base plate 11, the other end can be forced forward the central of the cylinder, and after force releasing, the elastic pieces 310 will spring back. The interlocking opening 32 located in the inside surface 120 of the lower base plate 12 is a ladder-shaped hole 320. The inside diameter of the fore part of the ladder-shaped hole 320 is smaller than the outside diameter of the clasp element 31. Pressing the clasp element 31, the elastic pieces 310 are forced to shrink the outside diameter of the clasp element 31, and the clasp element 31 enters into the clasp element 31 to engage with the ladder-shaped hole 320 of interlocking opening 32. Thus, the body 10 is closed and the filter 20 is fastened. Pulling the clasp element 31, the elastic pieces 310 are loosened from the ladder-shaped hole 320 of interlocking opening 32. Thus, the body 10 is open and the filter 20 is exchangeable.

In addition, the inside surface 110 of the upper base plate 11 and the inside surface 120 of the lower base plate 12 have, respectively, a rectangular inner frame 111 and a rectangular outer frame 121. The filter 20, bigger than the inner frame 111, is arranged between the inner frame 111 and the outer frame 121. When the body 10 is closed, the inner frame 111 is mounted into the outer frame 121, and the filter 20 is clamped between the inner frame 111 and the outer frame 121. When the body 10 is open, the filter 20 is exchangeable. On the top surface 112 of the upper base plate 11 has a control plate 16 which can open the body 10 conveniently. Each side of the control plate 16 has, respectively, a fast solid 18.

Referring to FIG. 5, firstly, the assembly process of the dust-proof filter apparatus is to open the body 10 to loosen the clasp element 31 from the interlocking opening 32, and arrange the upper base plate 11 and the lower base plate 12 in an included angle properly. Then, the filter 20 bigger than the inner frame 111 is placed on the outer frame 121 of the inner frame 111, and the upper base plate 11 is bended to the position of the elastic buckle assembly. The clasp element 31 is forced into engagement with the interlocking opening 32 as the clasp element 31 is pressed. Thus, the body 10 is closed and the filter 20 is fastened. The assembly process is convenient. The dust-proof apparatus can install in the inlet of a conditioner or a cooling system to filter particles.

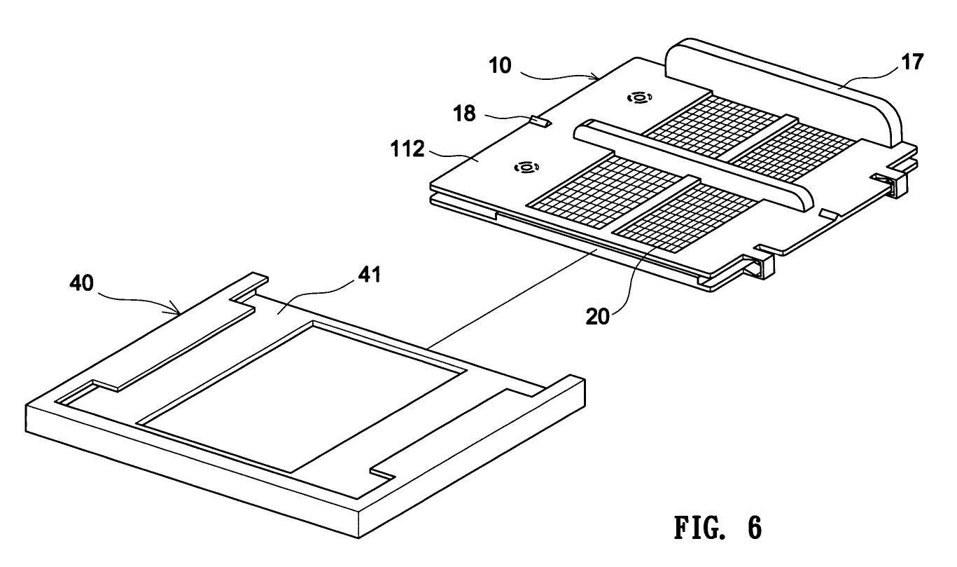

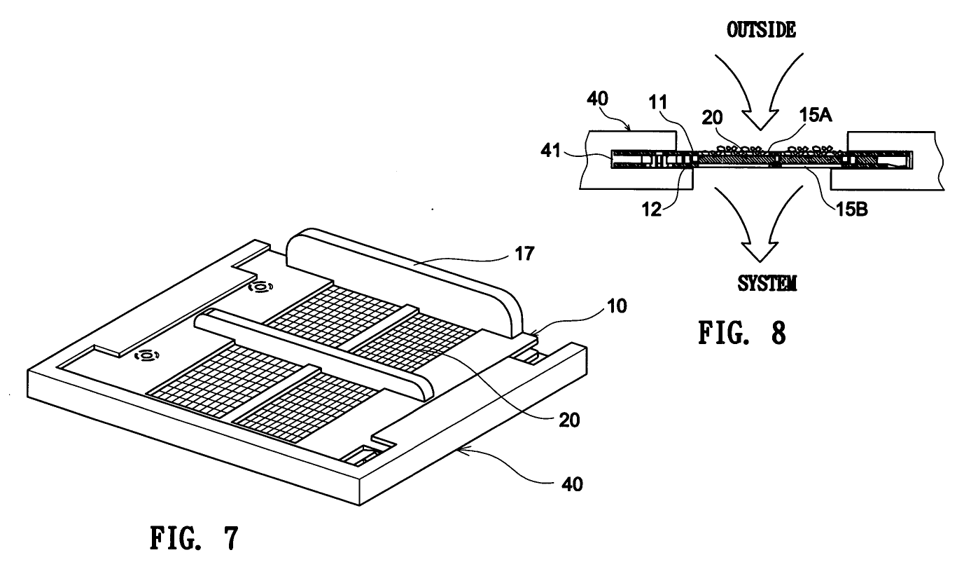

Referring to FIG. 6, a sliding way 41 is placed into a base 40 of the conditioner or the cooling system. The top surface 112 of the body 10 of the dust-proof apparatus further comprises a push-pull plank 17 to push or pull the dust-proof filter apparatus conveniently. As shown in FIG. 7 and FIG. 8, by pushing the push-pull plank 17, the dust-proof filter apparatus is inserted into the sliding way 41, so that the dust-proof filter apparatus is mounted into the sliding way 41. The fast solid 18 is inserted into a slot (not shown) in the sliding way 41 in order to fasten the dust-proof filter apparatus. Air traveling through the opening 15A of the upper base plate 11, the filter 20 has dust trapped in the filter 20 so that the circulating air will be cleaner and go through the opening of the lower base plate 12 into the system for use. The fast assembly process for the dust-proof filter apparatus is convenient. As exchanging the filter for washing or cleaning, just pull the push-pull plank 17 to pull out the dust-proof filter apparatus. Then, pulling the clasp element 31, the elastic pieces 310 are loosened from the ladder-shaped hole 320 of interlocking opening 32. Thus, the body 10 is open and the filter 20 is exchangeable. In accordance to the method, it's convenient to take the filter 20 apart from the dust-proof filter apparatus.

It will be apparent to those skilled in the art that in light of the forgoing disclosure, many alternations and modifications are possible in the practice of this invention without departing from the spirit or scoop thereof. Accordingly, the scoop of the invention is to be considered in accordance with the substance defined in the following claims.

What is claimed is:

1. A dust-proof filter apparatus comprising:
a body which is [symbol] -shaped and has a receiving space with at least one connection end and at least one opening end;
at least one filter which is arranged into said receiving space; and
at least one elastic buckle assembly having a clasp element and an interlocking opening, which said clasp element and said interlocking opening are, respectively, located in the surface of said opening end of said body.

2. A dust-proof filter apparatus according to claim 1, wherein said clasp element could be engaged with said interlocking opening.

3. A dust-proof filter apparatus according to claim 1, wherein said receiving space comprises a inner frame and a outer frame, which said filter is arranged between said inner frame and said outer frame.

4. A dust-proof filter apparatus according to claim 1, wherein said elastic buckle assembly is located in the -surface of said opening end opposite to said connection end.

5. A dust-proof filter apparatus according to claim 1, wherein said elastic buckle assembly is located in the -surface of said opening end adjacent to said connection end.

6. A dust-proof filter apparatus according to claim 1, wherein the top surface of said body further comprises a push-pull plank.

7. A dust-proof filter apparatus according to claim 1, wherein said body is mounted on a sliding way of a cooling system.

8. A dust-proof filter apparatus according to claim 1, wherein said body has at least one opening in the surface corresponding to the location of said filter.

9. A dust-proof filter apparatus according to claim 1, wherein said clasp element is composed of a plurality of elastic pieces to form a hollow cylinder, and said interlocking opening is a ladder-shaped hole.

10. A dust-proof filter apparatus according to claim 1, wherein said body further comprises a upper base plate and a lower base plate, which said upper base plate and said lower base plate is connected by at least one connection bond.

11. A dust-proof filter apparatus according to claim 10, wherein said filter is arranged between said upper base plate and lower base plate, and wherein said upper and lower base plate with at least one opening in the surface corresponding to the location of said filter.

12. A dust-proof filter apparatus according to claim 10, wherein said upper base plate, lower base plate and said connection bond are formed in one.

13. A dust-proof filter apparatus according to claim 10, wherein said connection bond is flexible.
